(19) United States
(12) Patent Application Publication
(10) Pub. No.: US 2006/0086024 A1
(43) Pub. Date: Apr. 27, 2006

(54) Home emergency sign - the home emergency table (HET)

(76) Inventor: Robert Joseph Kennedy, Charlotte, NC (US)

Correspondence Address: Robert Joseph Kennedy, 6521 Jupiter Lane, Charlotte, NC, 28213, US

(21) Appl. No.: 10/974,425

(22) Filed: Oct. 27, 2004

(51) Int. Cl. G09F 7/00

(52) U.S. Cl. 40/597

(57) ABSTRACT

A banner, called the Home Emergency Table (HET), allows information about a dwelling and its occupants to be communicated to response and recovery agencies, commercial service providers, and neighbors during or after emergencies or disasters. Seven broad categories of needs/concerns/conditions related to emergency/disaster survival are depicted: Shelter (Building), Communication, Health, Electricity, Animal, Transportation and Food. For each category depicted, at least one pictograph will symbolize the need/concern/condition. Each pictograph will have a heading above it indicating the category as well as a caption beneath it providing a brief description. The banner is made of a lightweight, flexible material such as vinyl. The paints/inks used on the banner will be of contrasting colors to increase visibility. Reinforced holes on the corners of the banner will allow the banner to be suspended or fixed in a position visible to responders. Nontransparent material is used to cover pictographs not intended to be displayed.

### CROSS-REFERENCE TO RELATED APPLICATIONS

| | Date Patent | | |
|---|---|---|---|
| Patent Number | Issued | Inventor | Classification |
| U.S. Pat. No. | Feb. 10, 2004 | Fink | 40/611.08 |
| 6,688,027 | | | |
| U.S. Pat. No. | May 11, 2004 | White | D20/42 |
| D489,767 | | | |
| U.S. Pat. No. | Apr. 11, 1995 | Schexnayder, Sr. | 362/34 |
| 5,406,463 | | | |
| U.S. Pat. No. | Apr. 4, 1989 | Vitale | 40/610 |
| 4,817,319 | | | |

### FEDERALLY SPONSORED RESEARCH OR DEVELOPMENT

Not applicable.

### REFERENCE TO SEQUENCING LISTING, A TABLE, OR COMPUTER PROGRAM

Not applicable. Not submitting a table of data as described in application guidelines.

### BACKGROUND OF INVENTION

The events of Sep. 11 ^{th}, 2001 have led government agencies and citizens to examine their emergency response and recovery procedures, particularly for more catastrophic events—man-made and naturally caused. New approaches have since been conceived and implemented to improve these capabilities; yet, more can be done to improve response and recovery performance.

In a catastrophic event, the lack of telephone service and electricity presents major problems in communicating needs to emergency responders. Further, in a large-scale event a large number of people and institutions needing assistance would make it difficult for all to contact responding agencies (e.g., telephone circuit overload). Many individuals requesting aid from agencies would have extensive waits for their needs to be addressed.

Response activities can be improved by including communication means other than electricity or telephone technologies. In addition, response may be improved in some cases if need requests reach aid providers other than traditional emergency responders (i.e., neighbors instead of governmental agencies).

Currently many recovery actions begin after initial damage assessments, which are commonly done by rapid surveys. The Federal Emergency Management Administration (FEMA) and the Centers for Disease Control and Prevention (CDC) are two agencies (or their local equivalents) involved with conducting these types of surveys. The initial FEMA damage assessments (Preliminary Damage Assessments) can be described as “windshield” surveys, generally conducted by viewing damage to structures from a vehicle as assessors pass through impacted communities (see http://www.fema.gov/rrr/pa/glossary.shtm). The CDC conducts Rapid Needs Assessment surveys, in which residents in selected impacted areas are interviewed about health, building damage, medical needs, food, and energy supply (see http://www.cdc.gov/mmwr/preview/mmwrhtml/mm5336a3.htm). Both FEMA and CDC surveys provide information to decision-makers so that they can make quick decisions on resource allocation. Animal response teams are also becoming more active in response and recovery operations, and they also must rely on information to direct their response and recovery activities (see State Animal Response Teams—http://www.sartusa.org/; County Animal Response Teams—http://www.cfawa.org/ColoradoSART/CART.htm).

The need for rapid assessment surveys is important; yet, currently they are methodologically flawed, limiting their validity. For example, the FEMA Preliminary Damage Assessment assesses facility damage viewed externally, generally not factoring internal damage into the assessment. The CDC Rapid Needs Assessment interviews only those residents physically present, not those absent at the time contact were attempted. There is a need for better ways to collect information on dwellings and individuals to more accurately understand the conditions and needs of communities stricken by a disaster. A sign providing pertinent information would address this need (US Patent Classification Definition: 40).

A review of patents on the US Patent Office Website (http://www.uspto.gov) was conducted on Oct. 19, 2004 under the search term “emergency sign.” This search produced 71 patents from the year 1976. Another search under the term “home emergency sign” produced no patents since 1976. Examination of the 71 patents from the term “emergency sign” showed a variety of types of items patented. For example, Fink developed a selectively reversible message board that allows pre-printed messages, such as “out of gas” to be displayed on one side, and hand written messages to be displayed on another side (U.S. Pat. No. 6,688,027). White designed an ornamental emergency sign, depicting “911”, that can be hung on door handles (U.S. Pat. No. 489,767). Schexnayder, Sr. described a chemi-luminescent display that can be used in creating emergency signs (U.S. Pat. No. 5,406,463). Vitale created a collapsible sign that incorporates a web supported by a collapsible frame that is easily deployed, disassembled, and stored (U.S. Pat. No. 4,817,319). None of these items serves the function of the Home Emergency Table—the HET.

### BRIEF SUMMARY OF INVENTION

The Home Emergency Table (HET) is a tool that improves emergency assessment capabilities associated with man-made and natural disasters (e.g., terrorism, criminal, accidents, hurricanes, ice storms, tornadoes, and floods). The table provides a simple means for residents to communicate problems and needs to emergency responders without slowing the assessment process and requiring individuals to be physically present at the time of assessment. In addition, community responders unaffiliated with a government agency, such as neighbors or church groups, can be informed of particular needs of dwelling residents. These community responders can then provide assistance, if possible, and government emergency responders are not available or are delayed serving other citizens. They may also serve as conduits to pass along information gathered to government responders.

### BRIEF DESCRIPTION OF THE VIEWS OF THE INVENTION

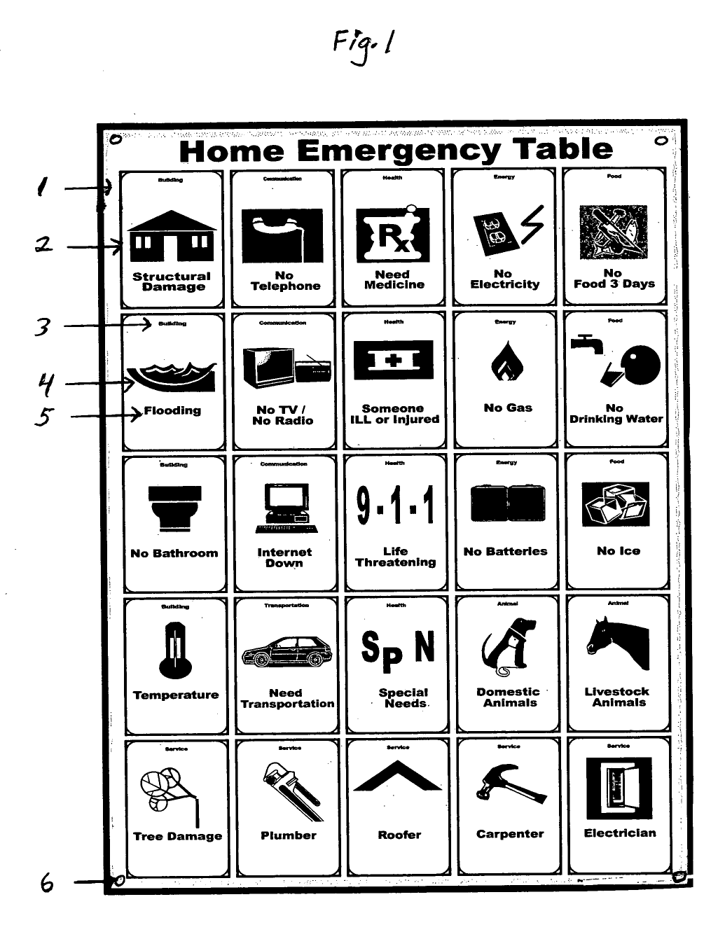

1) FIG. 1. The Home Emergency Table (HET)

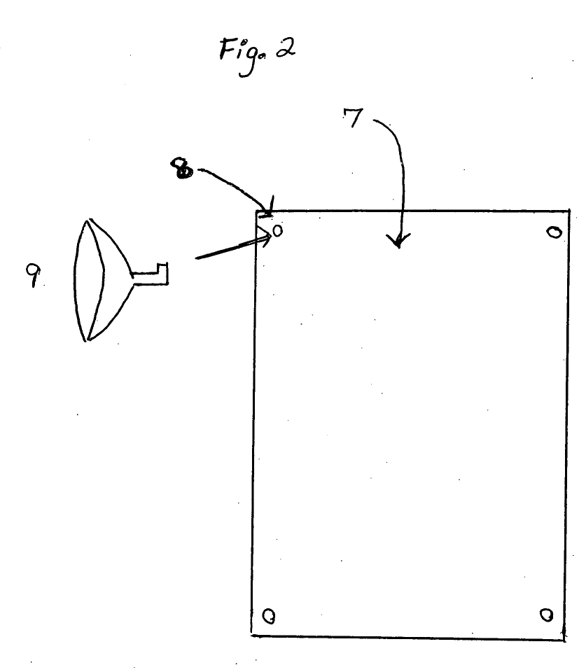

2) FIG. 2. The Support Mechanisms of the HET—a) suction cups, b) nails, c) and rope

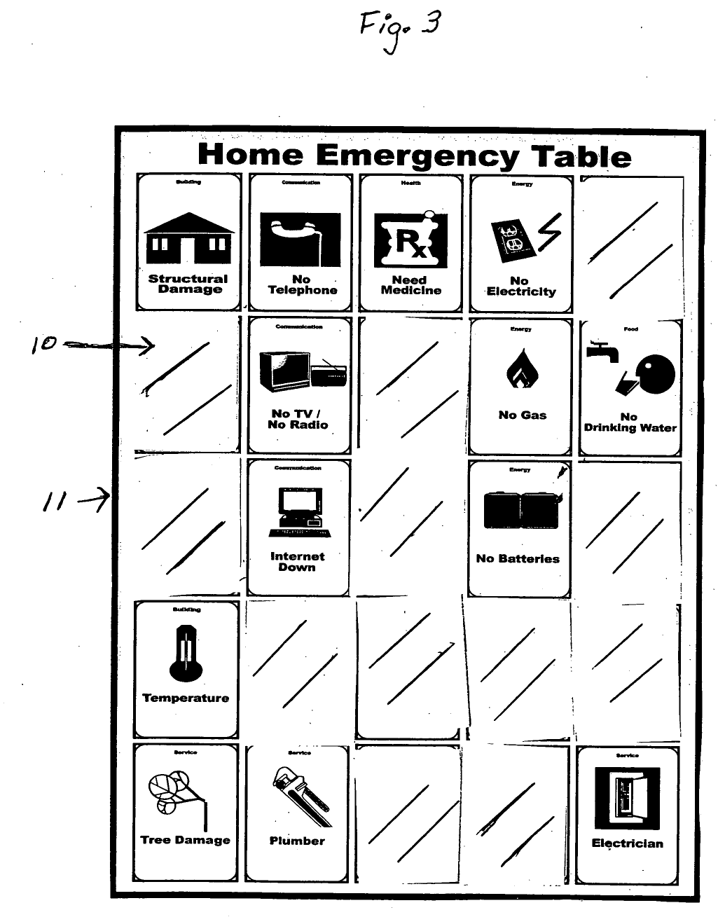

3) FIG. 3. Means to Cover Unwanted Symbols—a) Velcro strips, and b) button snaps

### DETAILED DESCRIPTION OF THE INVENTION

The HET is a banner that has as its column headers five areas important for surviving catastrophic events (Shelter, Communications, Health, Energy, and Food). There are essentially four rows under each column that contain symbols, which illustrate problems, or needs related to the specific areas. A fifth row contains symbols related to commercial contractor requests. By hanging the HET in a window, on a door, or from a tree in the yard, emergency or community responders will know the status of these key areas for a specific dwelling. In addition, the bottom row on the table will allow commercial contractors passing by to see if a dwelling occupant needs their services. While there is no column heading for domestic and livestock assistance, these needs are also incorporated into the HET (see Symbols, page 5).

Areas and Key Elements Communicated

Shelter

Structural damage—damage to roof, walls, flooring, windows that exceed minor repairs

Extreme in temperature—depending on season, either too cold or too hot for comfort or health

Flooding—appreciable amounts of water in the dwelling

Non-functional Bathroom—toilet does not flush to remove excrements

Communication

No working telephone

No working radio or television

No Internet

Health

Someone ill or injured

Need medicine or medical supply—in need of a prescription drug or medical apparatus (dialysis machine)

Special needs occupant—non-ambulant, elderly, mentally challenged

Need transportation to obtain medicines, medical supplies, or other items

Energy

No Electricity

No Gas

No Batteries

Food

Not enough food for three days

No potable water—water safe for drinking

No ice—especially a problem in summer and no electricity

Animals

Domestic animal needs assistance

Livestock animal(s) need assistance

Contractor Services Needed:

Roofer

Tree debris removal

Carpenter

Electrician

Plumber

9-1-1

Urgent, need help right away, life threatening event occurring

Material

The HET is constructed of pliable material such as 0.6 mil plastic, which is durable, yet lightweight. These properties allow the HET to be easily maneuvered from one location to another, rolled up, and stored when not needed. Translucent inks or paints are used to allow the signs to be visible at night when lights are directed towards them.

Symbols

The symbols in the six key response/recovery needs areas and commercial services were selected because they intuitively represent particular needs (FIG. 1). The symbols are essentially aligned in columns, columns of five key needs (Shelter, Communications, Health, Electricity, and Food). Communications, Electricity, and Food areas have only three symbols associated with these key areas, while Shelter and Health have four symbols. The third row under Communications will contain the “9-1-1” symbol, and Electricity and Food will have an Animal symbol domestic pet(s) need assistance and livestock need assistance, respectively. All symbols of the same key response/recovery area can similarly be color-coded uniformly to aid responders in interpreting needs (example: shelter/green; communication/yellow; health/blue; electricity/purple; food/red; animal/brown). The symbol for “9-1-1” will be coded different from all others to emphasize its expression of urgency. An instruction sheet with definitions of symbols and color-coding will provide users of the HET a clear understanding of their meanings.

Dimensions

Various sizes of the HET can be created to fit different window sizes or use outside the house. For example, a review of a home improvement store catalogue provides dimensions of widths of 25^{1/4}-to-37^{3/4}-inches and lengths of 41^{1/4}-to-65^{3/4}-inches for one brand of windows. Smaller versions can be made to hang on doors, larger sizes to be hung outside dwellings.

Support

Metal or plastic rings are located at each of the corners of the HET. Suction cups with hooks are used to hang the HET in windows. Nails, hangers, string/rope can be used to support the HET outside the dwelling (FIG. 2).

Communicating Specific Needs

Communicating specific needs is achieved by being able to select the appropriate needs on the HET. For HETs used inside the dwelling, Velcro strips on the HET can be attached to Velcro strips attached to non-transparent sheets of plastic (FIG. 3a). These sheets are the same size as an individual symbols (pictures) in the HET. By affixing these non-transparent sheets over inappropriate symbols, only symbols (pictures) of appropriate needs are visible to those passing by. For HETs used outside dwelling, plastic snaps can be used instead of Velcro to more aptly secure the non-transparent sheets (FIG. 3b). Instructions on how to cover unwanted symbols will make clear the process of displaying only appropriate symbols.

I claim the following:

1-20. (canceled)

21. A banner to be used by dwelling occupants during or after a natural or man-made disaster or emergency comprising:
a) a banner made of a durable, lightweight, and flexible plastic or vinyl that allows easy handling, suspension, and storage;
b) pictographs and/or words printed on a surface of the banner depicting common conditions, needs, and concerns that exist related to structure, occupants, property, and living conditions associated with or within the dwelling,
c) pictographs and/or words printed on the banner depicting typical contract services requested to repair damage associated with disasters or emergencies,
d) a non-transparent material cut to a size such that the material covers the pictographs and/or words not intended to be shown, thus allowing the selection of appropriate pictographs and/or words to be displayed by user, and
e) reinforced holes at each corner of the banner to suspend or fix the banner into position for display.

22. The banner of claim 21, wherein said banner will contain non-removable pictographs and words that are painted or otherwise permanently printed onto the banner.

23. The banner of claim 21, wherein said pictograph and words are printed in contrasting colors to enhance visibility.

24. The banner of claim 21, wherein each said pictograph will be framed by borders (printed onto the banner) forming a rectangle allowing each pictograph to distinctly separate from another.

25. The banner of claim 21, wherein to help dwelling users interpret the pictographs within each said frame, a small heading will be printed above each said pictograph, which will describe the pictograph (for example: Building, Communication, Health, Energy, Food Transportation, Animal, Service).

26. The banner of claim 21, wherein to help dwelling users interpret the pictographs within each said frame, a small caption will be printed below each said pictograph, which will describe pictograph.

27. The banner of claim 21, wherein said non-transparent materials can consist of self-adhesive paper or materials such as plastic, cloth, vinyl, or regular paper that can be affixed to the banner by use of tape or other adhesive, hook and loop fasteners, or snap buttons.

28. The banner claim 21, wherein said non-transparent materials could serve as a surface for dwelling occupants to write conditions, needs, concerns, or service needs not expressed by a printed pictograph on the banner or to write additional information about a pictograph that is displayed.

29. The banner of claim 21, wherein said banner can be suspended or otherwise fixed into position by use of suction cups, string, rope, nails, tacks, tape, or any combination thereof.

30. The banner of claim 21, wherein said banner can be located inside or outside a dwelling, such that persons passing by the dwelling can see it.
